(19) United States
(12) Patent Application Publication
(10) Pub. No.: US 2008/0267404 A1
(43) Pub. Date: Oct. 30, 2008

(54) Security System for Devices of a Wireless Network

(76) Inventors: Wolfgang Otto Budde, Aachen (DE); Oliver Schreyer, Herzogenrath (DE); Armand Lelkens, Heerlen (DE); Bozena Erdmann, Aachen (DE)

Correspondence Address: PHILIPS INTELLECTUAL PROPERTY & STANDARDS, P.O. BOX 3001, BRIARCLIFF MANOR, NY, 10510, US

(21) Appl. No.: 10/522,299

(22) PCT Filed: Jul. 25, 2003
(86) PCT No.: PCT/IB2003/002978

§ 371 Date: Jul. 11, 2008

(30) Foreign Application Priority Data
Jul. 29, 2002 (DE) 102 34 643.7

(51) Int. Cl. H04L 9/00

(52) U.S. Cl. 380/270

(57) ABSTRACT

The invention relates to a security system for wireless networks, comprising a first portable unit (1) with a memory (3) for storing a worldwide unambiguous key record (4) provided for short-range information transmission of the key record (4). At least one wireless apparatus (2) of the network is provided with a receiving unit (7) comprising a receiver (9) for receiving the key record (4) and an evaluation component (11) of the apparatus for storing, processing and/or passing on the key record (4) or a part of the key record to a second component. Due to the key record, the apparatuses in the wireless network acquire a secret shared key by means of which the encryption and decryption of the transmitted useful data and/or the authentication is performed. In accordance with an optional embodiment of the invention, the key record in the portable unit can be derived from biometric characteristics of a user.

The invention generally relates to a security system for wireless networks.

Wireless communication for supporting mobile apparatuses (such as mobile telephones) or as a substitution for wired solutions between stationary apparatuses (for example, PC and telephone connections) is already widely used.

For future digital home networks, this means that they no longer typically consist of only a plurality of wired apparatuses but also of a plurality of wireless apparatuses. When realizing digital wireless networks, particularly home networks, radio technologies such as Bluetooth, DECT and particularly the IEEE802.11 standard for “Wireless Local Area Network” are used. Wireless communication may also be realized via infrared (IrDA) connections.

Similarly, networks used for informing or entertaining the user will in future also comprise, inter alia, apparatuses which communicate with each other in a wireless manner. Particularly, so-called ad hoc networks are mentioned, which are temporarily installed networks, generally with apparatuses of different owners. An example of such ad hoc networks can be found in hotels: for example, a guest may want to reproduce the pieces of music on his MP3 player via the stereo installation of the hotel room. A further example are all kinds of encounters in which people with communicating wireless apparatuses meet each other for exchanging data or media contents (images, films, music).

When using radio technologies, apparatuses such as, for example, an MP3 storage apparatus and a hi-fi installation can communicate with each other in a wireless manner via radio waves as data connection. Principally, there are two modes. The apparatuses either communicate with each other directly from apparatus to apparatus (as a peer-to-peer network) or via a central access point as a distributor station.

Dependent on the standard, the radio technologies have ranges of several tens of meters in buildings (IEEE802.11 up to 30 m) and several hundred meters in the open space (IEEE802.11 up to 300 m). Radio waves also penetrate the walls of a dwelling or a house. In the frequency coverage of a radio network, i.e. within its range, the transmitted information may principally be received by any receiver which is equipped with a corresponding radio interface.

This makes it necessary to protect wireless networks from unauthorized or unintentional listening in to the transmitted information, as well as from unauthorized access to the network and hence to its resources.

Furthermore, an unambiguous identification of the target network should be possible for an apparatus which wants to re-associate itself with a given one of several networks located within the radio range.

Methods of access control and protection of transmitted information are described in the radio standards (for example, in “IEEE802.11. Wireless LAN Medium Access Control (MAC) and Physical Layer (PHY) specifications. Standard, IEEE”, New York, August 1999, chapter 8). In radio networks and also especially in the IEEE802.11 standard, any form of data security is finally based on secret encryption codes (keys) or passwords which are only known to authorized communication partners.

Access control means that a distinction can be made between authorized and unauthorized apparatuses, i.e. an apparatus granting access (for example, an access point, or an apparatus of a home or ad hoc network getting a communication request) may decide by means of transmitted information whether an apparatus requesting access is authorized. In a medium such as radio, which can easily be listened in to, the simple transmission of access codes or the use of identifiers (which can be compared by the apparatus granting access with a list of identifiers of authorized apparatuses) is inadequate because an unauthorized apparatus can gain access to the required access information by listening in to this transmission.

The MAC address filtering used in connection with IEEE802.11 does not ensure safe protection in its simple form. In this method, the access point stores the list of the MAC (Media Access Control) addresses of the apparatuses which are authorized to access the network. When an unauthorized apparatus attempts to access the network, it will be refused because of the MAC address which is unknown to the access point. In addition to the unacceptable user-unfriendly but necessary management of a MAC address list for home networks, this method particularly has the drawback that it is possible to fake MAC addresses. An unauthorized user only needs to gain knowledge about an “authorized” MAC address, which is simply possible when eavesdropping on radio traffic. Access control is therefore coupled to an authentication which is based on a secret key or password.

The IEEE802.11 standard defines the “shared-key-authentication” in which an authorized apparatus is distinguished by knowing a secret key. The authentication is then performed as follows. To ascertain the authorization, the apparatus ensuring access sends a random value (challenge) which the apparatus requesting access encrypts with the secret key and sends it back. The apparatus granting access can thus verify the key and hence the access authorization (this method is generally also referred to as “challenge response method”).

During encryption, the transmitted information is encrypted by the transmitting apparatus and decrypted by the receiving apparatus so that the data are worthless for an unauthorized or unintentional listener. To this end, the IEEE802.11 standard uses the Wired Equivalent Privacy (WEP) encryption method. In this method, a key (40-bit or 104-bit WEP key) which is known to all apparatuses in the network but is otherwise secret is used as a parameter in the encryption algorithm, laid down in the IEEE802.11 standard for encrypting the data to be transmitted.

In the case of WEP, the same key is also used for authentication.

In addition to “symmetrical” encryption methods (with a shared key) there are also public/private key methods in which each apparatus provides a generally known key (public key) for encryption and has an associated secret key (private key) which is known to this apparatus only, which provides the possibility of decrypting the information encrypted by means of the public key.

This provides listening security without a secret shared key which is known in advance. When using this method, it is, however, possible for an arbitrary apparatus to take up communication with an apparatus (for example, an apparatus granting access) while using the generally known key. Therefore, an authentication for access control is also required in this case which is again based on a secret key which should be known in advance to the communication partners.

For greater data security, network apparatuses may comprise mechanisms for agreements on temporary keys, i.e. keys used for encryption for a fixed period of time only so that the same secret key is not always used. However, the exchange of these temporary keys requires a listening-secure transmission which, in turn, requires at least a first secret key which should be known in advance to the communication partners. It is essential for the invention that the data security by way of encryption is also based on a (first) secret key which should be known in advance to the communication partners.

Consequently, a configuration step making a secret key (for authentication and/or encryption) available for all relevant apparatuses is necessary for providing a security system for wireless networks.

A particular aspect of wireless networks is that this key should not be transmitted as “clear text” (unencrypted) via the wireless communication interface because an unauthorized apparatus may gain unauthorized access to the key by listening in. It is true that a coding method such as the Diffie-Hellman method ensures safety from interception of an agreement on a secret shared key between two communication partners via a radio interface. However, to prevent an unauthorized apparatus from initiating the key agreement with an (access-granting) apparatus of the network, this method must also be coupled to an authentication of the communication partner, which in turn requires a (first) secret key which should be known in advance to the communication partners.

In mobile telephones based on the DECT standard, a first key has already been stored by the manufacturer in the apparatuses (base station and listener). To identify a new listener for the base station, the key (PIN number) which is stored in the base station should be given by the user to the new listener. Since the user should know the key for this purpose, it is available, for example, on stickers on the base station.

IEEE802.11-based company or campus networks with a dedicated infra structure are generally configured by specialist system administrators. They generally use system management computers having wired connections with each access point. Via these wired connections (and hence quasi listening-secure) connections, the secret keys (for example, WEP keys) are transmitted to the access points. The key input to clients (for example, wireless laptops) is effected manually.

It is assumed that a configuration step for installing a first secret key is performed (and that the required configuration steps are defined in software interfaces), but their realization is not fixed. To this end, chapter 8.1.2 of the IEEE802.11 standard comprises the following statement: “The required secret shared key is presumed to have been delivered to participating STAs (stations) via a secure channel that is independent of IEEE802.11. The shared key is contained in a write-only MIB (Management Information Base) attribute via the MAC management path.”

Performing a configuration step for installing a first (secret or non-secret) key as a network identifier is also a general condition for an automated configuration of wireless networks, because otherwise an apparatus (if radio-technically located within the range of several networks, e.g. the neighboring dwelling) cannot decide with which network it should associate itself.

It is an object of the invention to realize a user-friendly installation of a (preferably secret) key in the apparatuses of a wireless network.

The object is solved by a security system for wireless networks, comprising:

a first portable unit with a memory for storing a worldwide unambiguous key record provided for short-range information transmission of the key record, and

at least one receiving unit in at least one wireless apparatus of the network, comprising a receiver for receiving the key record and an evaluation component of the apparatus for storing, processing and/or passing on the key record or a part of the key record to a second component.

Each wireless apparatus of the network comprises a radio interface for transmitting useful data as well as a receiving unit for receiving a key record from a first portable unit. To secure the wireless useful data traffic between the apparatuses, a key record is supplied free from interception to each apparatus, by which these apparatuses acquire a secret shared key with which the transmitted useful data and/or the authentication can be encrypted and decrypted.

Additionally or alternatively, the key record can be used for network identification, i.e. to enable a new apparatus to couple into the “correct” network.

The key record is stored in the memory of the portable unit, comprising a transmitter or a transmitter with a detector unit for short-range transmission. The key record is thereby supplied free from interception to each wireless apparatus of the network. A button on the unit may be used for triggering the transmission of a key record. Dependent on the used method of short-range transmission of information, the transmission of a key record may also be triggered by bringing the unit into the vicinity of the receiving unit and by having the detector unit trigger the transmission of the key record.

The key record comprises a secret key code (“key”) as an essential (and possibly single) constituent. To receive the key record, each wireless apparatus of the network comprises a receiving unit which consists of a receiver and an evaluation component which, after acquiring the key record, extracts the key and passes on this key via an internal interface to the second component used for encrypting and decrypting the useful data (for example, the driver software used for controlling the radio interface).

A method of short-range transmission of information used by the portable unit may be based on modulated magnetic, electromagnetic fields such as infrared or visible light, ultrasound or infrasound or any other range-controllable transmission technologies. The transmission of the key record may also be realized by a multidimensional pattern on the surface of the transmitter, which is read by the receiving unit. It is essential for the invention that a technology having a very short range (few centimeters) or a short range and a strong local boundary (for example, infrared) is used so that the key record is supplied from a very short range and can in no case penetrate the walls of a room.

A particular advantage of this solution is that unauthorized persons cannot receive the key record. The transmission of the key record may be triggered by pressing a button on the portable unit or, for example, when using a radio frequency transponder technology (contactless RF tag technology) also by placing the portable unit in the vicinity of the receiving unit. By approaching the apparatus with the portable unit (or directing the unit onto the apparatus) and possible activation of a button on the unit, the input of the key record into an apparatus is thus very simple and uncomplicated for a user. The user neither needs to have any knowledge about the content of the key record or about the secret key. An expert for the input and administration of the key record is not necessary. The user friendliness is a further particular advantage of this solution.

The key record of the portable unit may be predetermined, for example, by the manufacturer and permanently stored in the memory of the unit.

In accordance with a further embodiment of the invention, the portable unit comprises an input device via which a user can store a key record in the memory. In the simplest case, the input device may be a keyboard via which the user can enter a code as key record. However, the input device may be alternatively a speech-recognition unit which derives a password from spoken words or sentences (independently of the speaker's identity) and stores it in the memory.

Furthermore, the input device may be adapted to detect biometric characteristics of a user and derive a key record from them. Deriving a key record from biometric characteristics of a user ensures that the key record is unambiguous worldwide.

When providing a key record via an input device (by explicit entry, detection of biometric characteristics or the like), the portable unit is preferably also adapted to erase said key record (including all correlated data) from the memory of the portable unit after a predetermined period of time of, for example, 30 seconds and/or after a predetermined processing procedure, for example, the transmission of the key record to an apparatus of a network. This means that the key record is not permanently stored in the portable unit, so that possession of the unit usually does not make abuse of the key record possible. The authorized user must rather enter the key record again, whenever he uses the portable unit. A particularly secure protection of the portable unit is therefore not necessary, which makes it possible to integrate the unit in many conventional apparatuses. For example, it could be part of a remote control (e.g. iPronto, Philips), a mobile phone, a USB dongle, etc.

Wireless networks, particularly home networks, should not only offer access for permanent users of the home network (for example, owners) but also provide, possibly limited, access for temporary users such as, for example, guests.

An advantageous further embodiment of the invention comprises a component denoted as key generator which is used for generating additional key records. The key generator is an additional component of the first portable unit or is realized in a second separate portable unit.

A key record generated by the key generator, referred to as guest key record, is built up in such a way that it can always be distinguished (for example, by special bits in the key record) from a (home) key record stored in the memory of the unit. When inputting a key record it is also always clear whether it is a home key record input or a guest key record input. To this end, the portable unit with the memory and the key generator has at least two buttons (one for triggering the transmission of the home key record from the memory and one for triggering the transmission of a guest key record). When the key generator is realized in a separate second unit, it is unambiguously distinguishable (for example, by way of its color, inscription, etc.) from the unit with the home key record.

A guest key record is used to grant guests access to resources of the network. To this end, a guest key record is input to all relevant apparatuses of the home network (i.e. the apparatuses available for use in connection with the guest's apparatuses) and the guest's apparatuses (which do not belong to the home network). With the aid of this guest key record, the guest's apparatuses (for example, laptop) can communicate with the relevant apparatuses of the home network. In an alternative version, the guest key record is made known once to the network (for example, by inputting it into one of the apparatuses belonging to the network) and is to be inputted only in the guest's apparatuses when required; all apparatuses of the network are then available for use with the guest's apparatuses. The control as to which data within the available apparatuses the guest is granted access should be realized at another location.

To enable the user to control the duration of the granted guest access to the home network, the guest key record in the home network apparatuses is automatically erased after a fixed period of time or by means of user interaction. A user interaction for erasing a guest key record may be, for example, the re-input of the current home key record, pressing a special button on the relevant home network apparatuses or one of the relevant home network apparatuses and subsequent automatic information of all other relevant home network apparatus by this apparatus.

To prevent unauthorized use of a guest key record by a previous guest, the key generator automatically generates a new guest key record in accordance with the challenge response method after a fixed period of time (for example, 60 minutes) after the last transmission of the guest key record. A new guest thus receives a guest key record which is different from the previous one so that it is ensured that the previous guest cannot utilize the presence of the new guest for unauthorized access to the home network.

Ad hoc networks represent a further development of wireless networks in which a number of apparatuses is to be temporarily made available for communication in a shared network. Similarly as with guest access to the home network, in which individual guest apparatuses are made available for access to the home network by means of a guest key record, apparatuses of other users should be able to communicate with at least one apparatus of the user in an ad hoc network. To this end, the user inputs a key record, here referred to as ad hoc key record, into all apparatuses of the ad hoc network (his own apparatuses and those of the other users) The ad hoc key record may be a guest key record but may also be unambiguously characterized as an ad hoc key record.

It is preferred that the key records consist of bit sequences, in which each bit sequence is transmitted in a predefined format (for example, as 1024-bit sequence).

The overall bit sequence or a part thereof is passed on as a key by the receiving unit. If the bit sequence comprises extra bits in addition to the key, it is exactly determined which part of the bit sequence is used as a key (for example, the 128 low-order bits) and which bits of the bit sequence comprise additional information. Further information may be characteristic features informing about the type of key record (home, guest or ad hoc record) or comprise details about the length and number of the key code if a plurality of key codes is transmitted simultaneously. If the receiving unit is used for further applications, the additional bits also characterize the use of the bit sequence as a key record.

In order to prevent use of the same (home) key in two neighboring home networks, it should be globally unambiguous. This can be achieved, for example, in that different unit manufacturers use different ranges of values for key codes and, in so far as possible, do not store the same key record within these ranges in two units at a time.

Furthermore, as elucidated above, a key record may be generated on the basis of biometric characteristics of a user.

A network operating in accordance with the IEEE802.11 standard is a widely known example of wireless home networks. In an IEEE802.11 network, the key record to be transmitted may comprise one or more Wired Equivalent Privacy (WEP) keys.

The input of the (home) key record may also take place in steps for the purpose of configuring the network so that the input/installation of the key record is desired at the start of the configuration. During the overall configuration process, an interception-free mutual communication between the apparatuses as well as an access control (all apparatuses having the key record are authorized) is thus ensured. Moreover, the key may also be used for network identification. This is particularly advantageous when applying automated configuration methods, i.e. methods without any user interaction (based on mechanisms such as, for example, IPv6 autoconfiguration and Universal Plug and Play (UPnP)).

In a preferred embodiment, the portable unit is integrated in a remote control unit of an apparatus of the home network.

The invention also relates to a portable unit for installing a shared key in at least one apparatus of a wireless network comprising a memory for storing a worldwide unambiguous key record which is provided for short-range information transmission of the key record.

Furthermore, the invention relates to an electric apparatus with a receiving unit comprising a receiver for receiving a key record and an evaluation component of the apparatus for storing, processing and/or passing on the key record or a part of the key record to a second component.

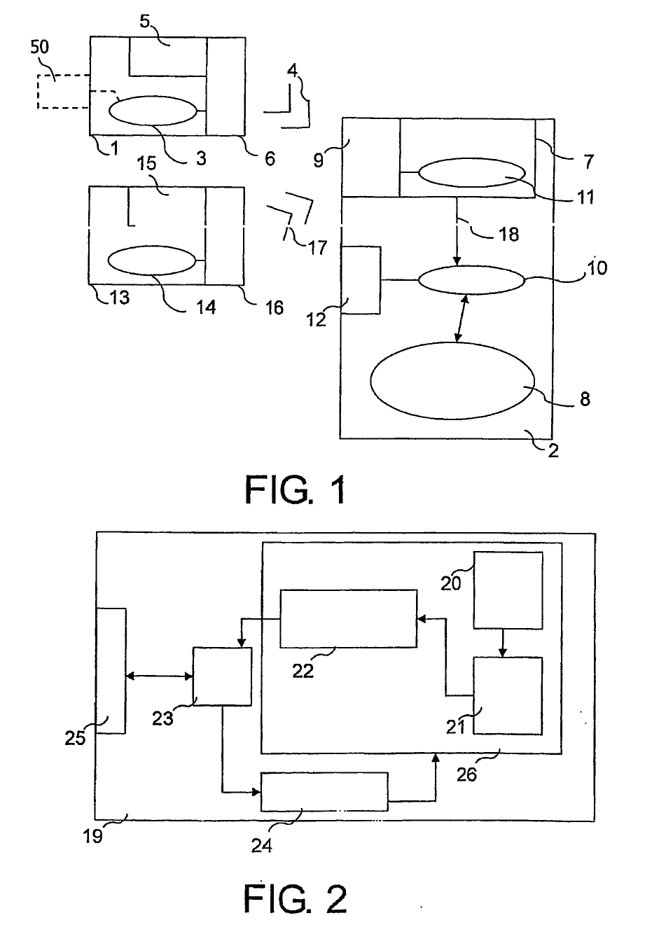

Embodiments of the invention will be elucidated hereinafter with reference to FIG. 1.

FIG. 1 shows diagrammatically two units and one apparatus,

FIG. 2 is a block diagram of a unit as a transmitting unit when using RF transponder technology,

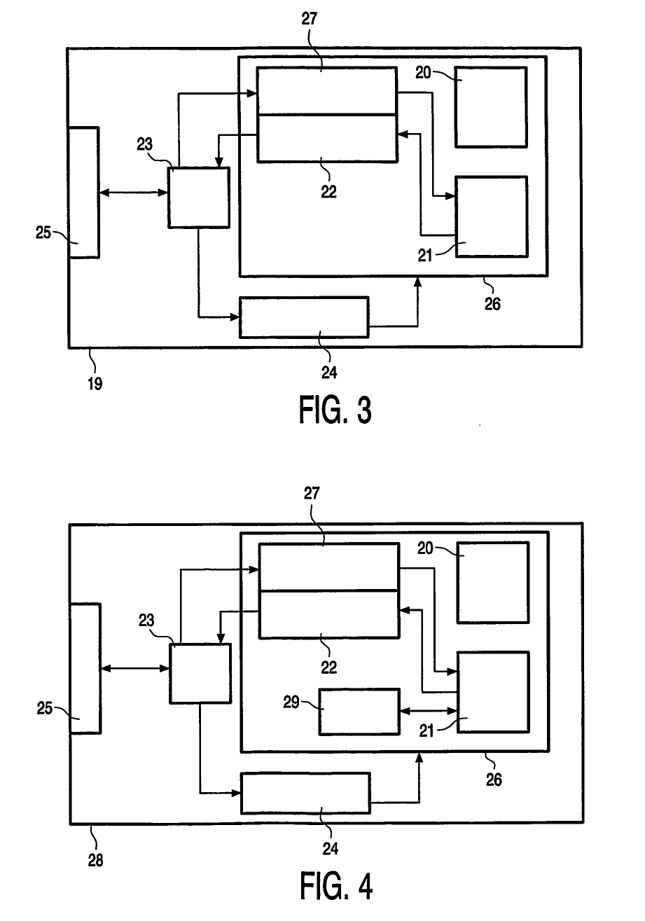

FIG. 3 is a block diagram of a unit as a receiving and transmitting unit when using RF transponder technology, and

FIG. 4 is a block diagram of a unit as a guest unit when using RF transponder technology.

The installation of an electric apparatus in a home network, here consisting of wireless and wired apparatuses (not shown) will be described with reference to FIG. 1. The Figure shows a first, portable unit 1, a guest unit 13 and a personal computer (PC) 2 as an apparatus which is new in the home network. All of the wireless apparatuses in the home network have corresponding components 8 to 12 described by way of the PC 2 example.

The first unit 1 comprises a memory 3 for storing a key record 4, a first button 5 as a unit for triggering a key transmission and a first transmitter 6 used as a wireless interface for transmitting the key record 4. The unit 1 has a short range of maximally about 50 cm.

The guest unit 13 comprises a component denoted as key generator 14 for generating key records, for example, in accordance with the challenge response principle, a second button 15 and a second transmitter 16. The guest unit 13 enables guests with their own apparatuses (not belonging to the home network) to have, possibly limited, access to the apparatuses and applications of the home network. A key record generated by the key generator 14 is therefore denoted as guest key record 17.

The PC 2 is an apparatus equipped with a radio interface 12 operating in accordance with the IEEE802.11 standard. This radio interface 12 is controlled by a component denoted as driver software 10 and is used for transmitting useful data (music, video, general data, but also control data). The driver software 10 may be operated by other software components via standardized software interfaces (APIs). The PC 2 is also equipped with a receiving unit 7. The receiving unit 7 comprises a receiver 9 provided as an interface for receiving the key record 4 or 17 transmitted by transmitter 6 or 16. The receiving unit 7 is provided with receiver software 11 as an evaluation component which, after obtaining a key record, extracts a key 18 therefrom (for example, a Wired Equivalent Privacy (WEP) key defined in the IEEE802.11 standard) and passes on this key 18 via a standardized management interface (as MIB (Management Information Base) attribute in the IEEE802.11 standard) to the driver software 10. The PC 2 is provided with application software 8 required for operating the PC.

A user would like to install the PC 2 in the home network and radio-connect it to a hi-fi installation in the home network in order that he can play back a plurality of music files in MP3 format on the hi-fi installation, which MP3 files are stored in the PC 2. To this end, the user approaches the PC 2 with the unit 1 and starts a transmission of the key record 4 stored in the memory 3 by directing the transmitter 6 of the unit 1 from a distance of several centimeters at the receiver 9 and pressing the button 5 on the unit 1.

When transmitting the key record 4, infrared signals are used. The format of the key record 4 is a 1024-bit sequence from which the receiver software 11 extracts the 128 low-order bits and passes them on as a (WEP) key 18 to the driver software 10. In the driver software 10, this key 18 is used for encrypting the data traffic between the PC 2 and the hi-fi installation as well as other apparatuses which have also been fed with the key record 4. This also relates to the required communication with the apparatuses already present in the network, subsequent to the autoconfiguration of the network connection of the PC to the home network (for example, configuration of an IP address).

Different circumstances may require the installation of a new key, for example when the user has lost the unit, when a new apparatus must be installed or when the user suspects that his home network is no longer protected. Fundamentally, a new unit with a new key record can overwrite the latest input of the (old) key record, for which the new key record must then be supplied to all apparatuses of the home network.

Abusive input of a new key record into the home network may be prevented in that at least one apparatus of the home network is not freely accessible to unauthorized persons. After unauthorized input of the new key record into the other apparatuses of the home network, this apparatus can no longer communicate with these apparatuses and trigger, for example, a corresponding alarm.

To enhance the security of the home network, it may, however, be compulsory that the old key record 4 must be additionally supplied with the input of a new key record. To this end, the user approaches the PC 2 or another apparatus in the home network with the old and the new unit. The user presses the button 5 on the old unit 1 for (re-)transmission of the old key record 4. A short moment later, the user starts the transmission of the new key record by pressing the button on the new unit for triggering the transmission.

The receiver software 11 of the PC 2 registers the reception of the old key record 4 and subsequently receives the new key record. The receiver software 11 passes on the new key record or the key via the management interface to the driver software 10 of the radio interface 12 only on condition that the receiver software 11 has previously registered the reception of the old key record 4. In order that the data traffic can be encrypted on the basis of the new key, the new key record must be supplied, as described above, to all apparatuses of the home network.

An increased extent of security when inputting a new key record can be achieved when the receiver software 11 only accepts the input of a new key record, i.e. passes on the key in this record, when the new key record has been supplied several times and at certain time intervals to the apparatus, the number of times and time intervals of the required inputs being known to the user only.

An increased extent of security of the home network may also be achieved in that a key record must be regularly supplied again to at least one of the apparatuses of the home network after expiration of a given period of time (several days/weeks/months).

In the invention described so far, it was assumed that the key record is stored in the memory 3 of the portable unit 1. Such storage may take place, for example, in the factory manufacturing the portable unit. Moreover, broken lines in FIG. 1 indicate an alternative possibility of providing a key record in the memory 3. This possibility requires an input device 50 on the portable unit 1, enabling a user to input a key record and store it in the memory 3.

The input device 50 is preferably an apparatus for reading biometric characteristics, which, together with processing software, is implemented to analyze sensor-detected biometrical data. Apparatuses for reading biometric characteristics are widely known and therefore do not need to be explained individually. Technologies that can be used in this field comprise, for example:

fingerprint analysis, which will hereinafter be considered as a substitute example;

speech recognition;

retina scanning;

DNA analysis;

auricle shape analysis;

hand shape analysis;

machine-processing of inscriptions and signatures, including

analysis of writing speeds and pressure changes.

The input device 50 can derive a (worldwide unambiguous) key record from the biometric characteristics of a user, ensuring that only the authorized user possesses or is able to input this key record.

The input device may also be a speech recognition unit (in contrast to speaker recognition), which generates the key record from a special speech input by the user.

The input of a key record by a user also renders it unnecessary to have the sensitive data permanently available in the memory of the portable unit 1. In fact, the user can input the key record into the memory 3 any time, for example, by way of a new fingerprint analysis. Consequently, the portable unit no longer needs to be safeguarded and protected from unauthorized access, so that it can be integrated, particularly as an additional function, in an available apparatus such as, for example, a remote control unit, an iPronto (Philips), a mobile phone with Bluetooth or IrDA interface, a USB dongle or the like. A condition for this is that, for reasons of security, the home key record is erased from the portable unit 1 as soon as it was transmitted to a network apparatus 2 or as soon as a predetermined time interval of, for example, 30 seconds has elapsed after input of the key record via the input device 50.

By means of the guest unit 13, the user can grant a guest access to the PC 2. To this end, the guest or the user approaches the PC 2 and, by pressing the button 15, triggers the transmission of the guest key record 17 generated by the key generator 14.

The guest key record 17 consists of a bit sequence with additional bits for transmitting further information. The additional bits characterize the key record as guest key record and are used for distinguishing the key record from other information if the receiving unit is used as an interface for further applications.

The receiving unit 7 receives the guest key record 17. The receiver software 11 identifies the key record by way of the additional bits as guest key record 17 and passes on the extracted key as an additional (WEP) key via the management interface to the driver software 10 of the radio interface 12. The driver software 10 uses the key as an additional key for encrypting the data traffic.

In the Wired Equivalent Privacy (WEP) encryption defined in the IEEE802.11 standard, a parallel application of up to four WEP keys is provided. The apparatuses of the network are capable of recognizing which WEP key is currently used for encryption.

The input of the guest key record 17 is repeated for all apparatuses of the home network which the guest would like to use, as well as for all apparatuses of the guest (for example, laptop) with which he would like to get access to the home network, for example, to the MP3 files on the PC 2.

To enable the user to control the duration of the granted guest access to the home network, the guest key record 17 is automatically erased in the apparatuses of the home network after a fixed period of time (for example, 10 h) or by user interaction (for example, input of the home key record 4 into the home network apparatuses).

To prevent unauthorized use of a guest key record by a previous guest, the key generator automatically generates a new guest key record in accordance with the challenge response principle after a fixed period of time.

FIG. 2 is a block diagram of a portable unit 19 for use with a RF transponder technology for transmitting the key record 4. The portable unit 19 consists of a digital part 26 comprising a memory 20 (such as, for example, ROM) for storing the key record, a program run control unit 21 and a modulator 22 for converting a bit stream coming from the program run control unit 21 into RF signals to be transmitted. Furthermore, the unit 19 comprises a splitter 23 for separating the electromagnetic energy received from a passive component designated as antenna 25 from the RF signal to be transmitted, a power supply unit 24 with a voltage detector for supplying the digital part 26 with an operating voltage and the antenna 25 for transmitting the bit stream coming from the splitter 23 and for receiving the energy required for operation.

To transmit the key record 4, the user approaches the receiving unit 7 with the portable unit 19. The antenna 25 passes on the incoming energy from the receiving unit 7 via the splitter 23 to the power supply unit 24 with the voltage detector. When a threshold value of the voltage is exceeded in the voltage detector, the power supply unit 24 provides an operating voltage in the unit 19. Excited by the operating voltage, the program run control unit 21 is initialized and reads the key record stored in the memory 20. The key record is embedded in an appropriate message format by the program run control unit 21 and passed on to the modulator 21 for conversion into analog RF signals. The RF signals are transmitted by the antenna 25 via the splitter 23.

FIG. 3 shows the unit 19 as a receiving and transmitting unit while applying the same technology as in FIG. 2. In this Figure, identical or corresponding elements and components have the same reference numerals as those in FIG. 2. In so far, reference is made to the description of FIG. 2 and only the differences will be elucidated hereinafter.

In this embodiment, the unit 19 comprises the modulator 21 as well as a demodulator 27. The memory 20 is realized by an erasable memory such as, for example, an electrically erasable memory of an EEPROM.

Due to the demodulator 27, the unit 19 is capable of converting an RF signal received by the antenna 25 (additionally to the incoming energy) and passed on via the splitter 23 into a bit sequence. The bit sequence coming from the demodulator 27 is processed by the program run control unit 21. The processing of the bit sequence may result in an access of the program run control unit 21 to the memory 20 if the program run control unit 21 determines that the bit sequence comprises information authorizing the receiving unit to receive the key record. If the receiving unit is authorized to receive the key record, the program run control unit 21 reads the key record and passes it on, in the manner as described in FIG. 2, to the antenna 25 for transmission.

The demodulator 27 further provides the possibility of introducing a new key record into the unit 19. When the memory 20 is realized as a writable memory (for example, EEPROM), the key record in the unit 19 can be replaced by a new key record.

FIG. 4 shows the unit 19 as a guest unit 28 while applying the same technology as in FIG. 2. In this Figure, identical or corresponding elements and components are also denoted by the same reference numerals as those in FIG. 3. In so far, it will be described with reference to FIG. 3 and only the differences will be elucidated hereinafter.

The guest unit 28 additionally comprises a key generator 29 which is connected to the program run control unit 21 and is used for generating a sequence of guest key records.

After the energy coming in through the antenna 25 in the vicinity of the receiving unit 7 is detected with the voltage detector in the power supply unit 24, the digital unit 26 is supplied with an operating voltage by the power supply unit 24. The program run control unit 21 reads a key record generated by the key generator 29. After the program run control unit 21 has received the key record and has embedded it in an appropriate message format, it passes on this record for transmission to the modulator 22 and simultaneously writes the key record into the memory 20 which must be formed as a writable memory (for example, EEPROM) for this purpose.

In a second mode of operation, a new key record is generated by the key generator within regular intervals (for example, several minutes or hours) and stored in the rewritable memory 20. The further procedure then corresponds to that described with reference to FIGS. 2 and 3.

The embodiment of the unit 19 with the key generator as shown in FIG. 4 can also be combined with the embodiment (without the demodulator 27) shown in FIG. 2.

1. A security system for wireless networks, comprising:
a first portable unit (1) with a memory (3) for storing a worldwide unambiguous key record (4) provided for short-range information transmission of the key record (4), and
at least one receiving unit (7) in at least one wireless apparatus (2) of the network, comprising a receiver (9) for receiving the key record (4) and an evaluation component (11) of the apparatus for storing, processing and/or passing on the key record (4) or a part of the key record to a second component.

2. A security system as claimed in claim 1, characterized in that the worldwide unambiguous key record (4) in the memory (3) of the portable unit (1) is predetermined by the manufacturer.

3. A security system as claimed in claim 1, characterized in that the portable unit (1) comprises an input device (50) for providing a key record to the memory (3).

4. A security system as claimed in claim 3, characterized in that the input device (50) is adapted to detect biometric characteristics of a user and derive a key record from and/or authenticate the user by means of said biometric characteristics.

5. A security system as claimed in claim 3, characterized in that the portable unit (1) is adapted to erase a key record provided by means of the input device (50) from the memory (3) after a predetermined period of time and/or after a processing procedure.

6. A security system as claimed in claim 1, characterized in that the first unit (1) comprises a triggering unit (5) for triggering a short-range transmission of the key record.

7. A security system as claimed in claim 1, characterized in that, upon a user's approach to the receiving unit (7), a detector unit in the unit (1) triggers the short-range information transmission of the key record (4).

8. A security system as claimed in claim 1, characterized in that a key generator (14) is provided in the first unit (1) or in a second unit (13) for generating a sequence of guest key records (17).

9. A security system as claimed in claim 6, characterized in that the first unit (1) is provided for transmitting a guest key record (17) upon activation of a second triggering unit (15).

10. A security system as claimed in claim 1, characterized in that the key record (4) and the guest key record (17) each consist of a bit sequence.

11. A security system as claimed in claim 1, characterized in that the first unit (1) is a part of an apparatus, particularly a remote control unit.

12. A security system as claimed in claim 1, characterized in that the key record (4) is supplied during or before a network configuration, particularly an automatic network configuration, of an apparatus (2).

13. A security system as claimed in claim 10, characterized in that the key record (4) and the guest key record (17) comprise characterizing bits which are provided for distinguishing between key records (4, 17) and other bit sequences and characterize bit sequences as key record (4) or as guest key record (17).

14. A security system as claimed in claim 8, characterized in that the apparatus (2) is provided for erasing the guest key record (17).

15. A security system as claimed in claim 1, characterized in that the apparatus (2) is provided for authentication and encryption of useful data to be transmitted between the apparatuses of the network by means of a key comprised in the key record (4, 17).

16. A security system as claimed in claim 1, characterized in that the apparatus (2) identifies its association with a wireless network by means of a key comprised in the key record (4, 17).

17. A portable unit (1) for installing a shared key in at least one apparatus (2) of a wireless network comprising a memory for storing a worldwide unambiguous key record (4) which is provided for short-range information transmission of the key record.

18. An electric apparatus (2) with a receiving unit (7) comprising a receiver (9) for receiving a key record (4) and an evaluation component (11) of the apparatus (2) for storing, processing and/or passing on the key record or a part of the key record to a second component (10).
